(19) United States
(12) Patent Application Publication
(10) Pub. No.: US 2026/0154259 A1
(43) Pub. Date: Jun. 4, 2026

(54) End-to-end SQL generation and editing

(71) Applicant: Distyl AI, Inc., San Francisco, CA (US)

(72) Inventors: Karime Maamari, Los Angeles, CA (US); Connor Landy, Austin, TX (US); Amine Mhedhbi, Outremont (CA); David Lisuk, Brooklyn, NY (US)

(21) Appl. No.: 19/456,534

(22) Filed: Jan. 22, 2026

Related U.S. Application Data
(63) Continuation of application No. PCT/US2026/011592, filed on Jan. 16, 2026.
(63) Continuation-in-part of application No. PCT/US2025/050087, filed on Oct. 8, 2025.
(60) Provisional application No. 63/704,637, filed on Oct. 8, 2024.
(60) Provisional application No. 63/746,158, filed on Jan. 16, 2025.

(51) Int. Cl. G06F 16/242; G06F 16/2455; G06F 16/248

(52) U.S. Cl. CPC G06F 16/2428; G06F 16/243; G06F 16/2455; G06F 16/248

(57) ABSTRACT

Embodiments include systems and methods for end-to-end structured language query editing. In some embodiments, a method includes executing a structured language query generated from a natural language query using a knowledge set; receiving, at an interactive user interface from a user, natural language feedback regarding the execution of the structured language query; updating the knowledge set based on the natural language feedback; and regenerating the structured language query based on the updated knowledge set.

### CROSS-REFERENCE TO RELATED APPLICATIONS

The present application is a continuation of International (PCT) Patent Application No. PCT/US2026/011592, filed internationally on Jan. 16, 2026, claims the benefit of and priority to U.S. Provisional Application No. 63/746,158, filed on Jan. 16, 2025, and is a continuation in part of PCT Application No. PCT/US2025/050087, filed on Oct. 8, 2025, which itself claims the benefit of and priority to U.S. Provisional Application No. 63/704,637, filed on Oct. 8, 2024. The entire disclosure of each of these applications is hereby incorporated by reference as if set forth in its entirety herein.

### TECHNICAL FIELD

Embodiments described herein generally relate to systems and methods for structured language query generation and editing and, more particularly but not exclusively, to systems and methods for end-to-end structured language query generation and editing.

### BACKGROUND

The demand for democratized access to data has increased substantially in recent years, fueled by the pervasive need for data-driven decision making across various domains such as finance, healthcare, manufacturing, logistics, and consumer technology. In modern enterprises, the ability to query and analyze large volumes of structured data is often critical for gaining business insights, monitoring operations, and ensuring compliance with regulatory requirements. However, traditional approaches to data access and analytics typically require specialized expertise in database management systems (DBMS) and proficiency in structured languages such as Structured Query Language (SQL). This technical barrier excludes a wide range of potential users, such as business analysts, managers, and domain experts, who may lack the requisite experience but nevertheless require direct access to data to perform their roles effectively.

To overcome this limitation, text-to-SQL systems have been developed to automatically translate natural language into executable SQL (and/or other structured language) queries. Such systems have expanded access to data analytics by allowing non-technical users to analyze data from databases without requiring specialized database knowledge.

Current text-to-SQL solutions, however, suffer from several major shortcomings. First, current solutions predominantly employ rule-based techniques, template-driven approaches, or semantic parsers. This causes current solutions to be rigid in structure and struggle with complex and varied natural language inputs. For instance, some approaches attempt to simplify query generation through syntax tree parsing and intermediate representations. Although effective for limited query classes, such approaches often fail to capture the contextual nuances of user intent, resulting in inaccuracies, inefficiencies, and an inability to handle complex or domain-specific queries.

Second, many business or industry databases use domain-specific knowledge, such as domain-specific abbreviations or naming conventions. Current solutions, however, often fail to capture this domain-specific knowledge.

Lastly, current solutions often lack mechanisms for continuous improvement. Once deployed, their behavior may remain static unless an operator manually updates the solution. In particular, such solutions often do not update their knowledge sets to capture the latest domain knowledge.

Recent advancements in artificial intelligence, particularly the emergence of large language models (LLMs), provide new opportunities for text-to-SQL systems to eliminate past limitations. LLM-based approaches can leverage deep contextual understanding and generative capabilities to generate structured language queries with improved accuracy and continuously learn over time.

Accordingly, there exists a need for improved methods and systems for end-to-end structured language query generation.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, the techniques described herein relate to a computer-implemented method for structured language query editing, the method being executed by a processing system including at least one processor and memory, the method including: executing a structured language query generated from a natural language query using a knowledge set; receiving, at an interactive user interface from a user, natural language feedback regarding the execution of the structured language query; updating the knowledge set based on the natural language feedback; and regenerating the structured language query based on the updated knowledge set.

In some embodiments, the method further includes: identifying, from the knowledge set, data relevant to the natural language feedback; and generating a chain-of-thought (CoT) reasoning plan based on the relevant data, wherein the knowledge set is updated based on the CoT reasoning plan.

In some embodiments, the method further includes generating an explanation of why the data is relevant.

In some embodiments, the identifying the relevant data includes performing a similarity search based on at least one characteristic of the natural language feedback.

In some embodiments, the structured language query is generated using a second CoT reasoning plan.

In some embodiments, the knowledge set is repeatedly updated until the user approves a version of the structured language query.

In some embodiments, the method further includes presenting, at the interactive user interface, at least one of the updated knowledge set or the regenerated structured language query.

In some embodiments, the method further includes: presenting, at the interactive user interface, data regarding the execution of the structured language query; presenting, at the interactive user interface, at least one recommended edit to the knowledge set based on the natural language feedback; and receiving, at the interactive user interface, a selection of at least one recommended edit.

In some embodiments, the method further includes: executing the structured language query with the at least one selected edit at a test environment; and receiving, at the interactive user interface, approval from the user to regenerate the structured language query with the at least one selected edit.

In some embodiments, the knowledge set includes generation instructions and sub-expressions representing structured language queries.

In some embodiments, the knowledge set is partitioned according to a user intent of the natural language query.

In another aspect, the techniques described herein relate to a system for structured language query editing, including: an interactive user interface configured to perform the step of receiving, from a user, natural language feedback regarding an execution of a structured language query generated from a natural language query using a knowledge set; memory storing instructions; and a processor executing the instructions to perform the steps of: executing the structured language query; updating the knowledge set based on the natural language feedback received at the interactive user interface; and regenerating the structured language query based on the updated knowledge set.

In some embodiments, the processor is further configured to perform the steps of: identifying, from the knowledge set, data relevant to the natural language feedback; and generating a chain-of-thought (CoT) reasoning plan based on the relevant data, wherein the knowledge set is updated based on the CoT reasoning plan.

In some embodiments, the knowledge set is repeatedly updated until the user approves the regenerated structured language query.

In some embodiments, the interactive user interface is further configured to perform the step of presenting at least one of the updated knowledge set or the regenerated structured language query.

In some embodiments, the interactive user interface is further configured to perform the steps of: presenting data regarding the execution of the structured language query; presenting at least one recommended edit to the knowledge set based on the natural language feedback; and receiving a selection of at least one recommended edit.

In some embodiments, the processor is further configured to perform the step of executing the structured language query with the at least one selected edit at a test environment, and wherein the interactive user interface is further configured to perform the step of receiving approval from the user to regenerate the structured language query with the at least one selected edit.

In some embodiments, the knowledge set includes generation instructions and sub-expressions representing structured language queries.

In some embodiments, the knowledge set is partitioned according to a user intent of the natural language query.

In yet another aspect, the techniques described herein relate to a computer program product embodied in a non-transitory computer readable storage medium and including computer instructions for: executing a structured language query generated from a natural language query using a knowledge set; receiving, at an interactive user interface from a user, natural language feedback regarding the execution of the structured language query; updating the knowledge set based on the natural language feedback; and regenerating the structured language query based on the updated knowledge set.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a system for end-to-end structured language query generation in accordance with one embodiment.

FIG. 2 illustrates a flowchart of a method for end-to-end structured language query generation in accordance with one embodiment.

FIG. 3 illustrates a knowledge set for end-to-end structured language query generation in accordance with one embodiment.

FIGS. 4A and 4B illustrate a command-line interface for end-to-end structured language query generation in accordance with one embodiment.

FIGS. 5A and 5B illustrate a structured language query in accordance with one embodiment.

FIG. 6 illustrates a multi-stage pipeline for end-to-end structured language query generation in accordance with one embodiment.

FIG. 7 illustrates a flowchart of a method for end-to-end structured language query editing in accordance with one embodiment.

FIG. 8 illustrates a multi-stage pipeline for end-to-end structured language query generation and editing in accordance with one embodiment.

FIG. 9A illustrates a user interface for end-to-end structured language query generation and editing.

FIGS. 9B and 9C illustrate an alternate embodiment of the user interface depicted in FIG. 9A.

FIG. 9D illustrates another alternate embodiment of the user interface depicted in FIG. 9A.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

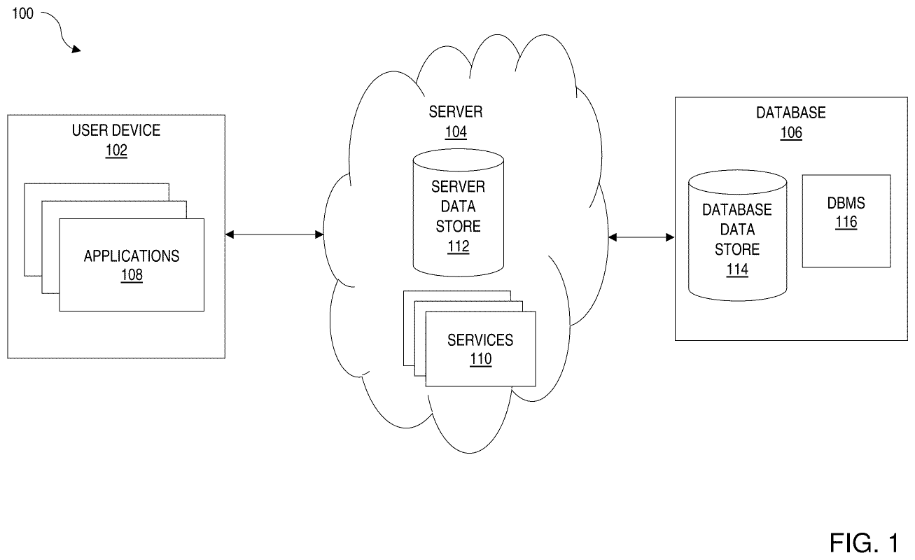

FIG. 1 illustrates a system 100 for end-to-end structured language query generation in accordance with one embodiment. The system 100 may include any number of components for performing operations related to structured language query generation. As shown, for example, the system 100 may include a user device 102, a server 104, and a database 106. Although one of each of the user device 102, the server 104, and the database 106 are shown, it is to be appreciated that the system 100 may include any suitable number of components.

The user device 102 may include any type or form of device that a user can interact with to perform one or more functions or operations. Exemplary user devices may include, but are not limited to, smartphones, tablets, personal computers (e.g., laptops, desktops, etc.), smartwatches, fitness trackers, and/or television sets.

As shown, the user device 102 may execute one or more applications 108. The user device 102 may include any number of processing and/or memory units to execute and store the applications 108. The applications 108 may include any suitable type of application, such as containerized applications, web programs, deployment tools, security services, data services, database applications, and/or data analytics platforms. The applications 108 may allow the user to interact with data and/or services from remote systems, such as data and/or services provided by the server 104 and/or database 106. The applications 108 may provide user interfaces for interacting with the data and/or services.

The server 104 may be configured to provide one or more services 110 to external devices and/or systems, such as the user device 102. The server 104 may include any suitable type or form of server, such as a web server, a database server, an application server, and/or a virtualization server. The server 104 may be configured to process data and/or interpret, execute, and/or direct execution of one or more of the instructions, processes, and/or operations described herein. For example, the server 104 may perform various operations related to end-to-end structured language query generation.

The services 110 may include any suitable type of service provided by the server 104, such as security services, authentication services, communication services, web services, database services, storage services, knowledge management services, and/or data analytics services.

The server 104 may include a server data store 112 for storing data and/or instructions, such as data related to end-to-end structured language query generation. The server data store 112 may include one or more data storage media, devices, or configurations and may employ any type, form, and combination of data storage media and/or device. For example, the server data store 112 may include, but is not limited to, any combination of the non-volatile media and/or volatile media described herein. Electronic data, including data described herein, may be temporarily and/or permanently stored at the server data store 112. For example, computer-executable instructions configured to direct server processing units to perform any of the operations described herein may be stored within the server data store 112. In some examples, the server data store 112 may store a knowledge set used for structured language query generation.

The database 106 may include any suitable database for managing data at a database data store 114, such as a relational database, a distributed key-value store, a document-oriented database, and/or a graph database. The database 106 may manage data for a particular domain and/or business entity, such as a healthcare center and/or financial institution. The database 106 may manage structured data using a database management system (DBMS) 116. The DBMS 116 may execute various operations for managing data at the database data store 114. For example, the DBMS 116 may receive structured language queries (e.g., SQL commands) from a requesting entity (e.g., the user device 102), parse the queries, and return results to the requesting entity. In some examples, the DBMS 116 may provide various services for the database 106, such as transaction management services, concurrency control services, indexing services, data integrity services, and/or optimization services.

In a traditional configuration, the structured language queries may be directly received from a user, such as a user of the user device 102. For example, the user may directly input a SQL command at the user device 102 (e.g., via the applications 108). The database 106 may receive the SQL command, parse the command using the DBMS 116, and return a result set based on data from the database data store 114. The user may view the result set using a user interface presented at the user device 102.

In some embodiments, the system 100 may generate structured language queries based on natural language inputs (e.g., natural language queries). For example, the user may input a natural language query at the user device 102. The user device 102 may send the natural language query to the server 104. The server 104 may generate a candidate structured language query based on the natural language query (e.g., via the services 110). The server 104 may send the candidate structured language query to the database 106, which may process the query and return a result set based on data from the database data store 114.

Further details regarding the structured language query generation are described herein.

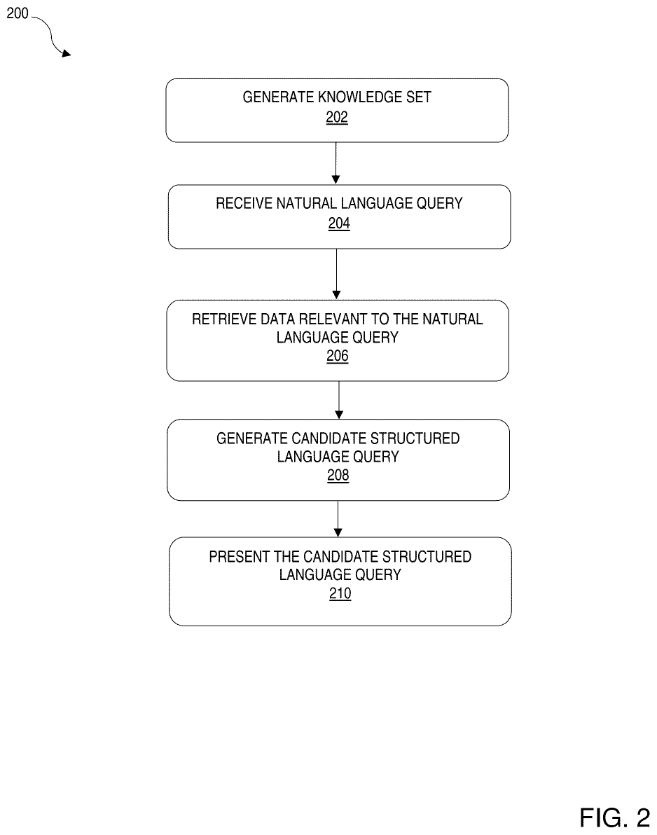

FIG. 2 illustrates a flowchart of a method 200 for end-to-end structured language query generation in accordance with one embodiment. While FIG. 2 shows illustrative operations according to one embodiment, other embodiments may omit, add to, reorder, and/or modify any of the operations shown in FIG. 2. Moreover, each of the operations depicted in FIG. 2 may be performed in any of the ways described herein. The operations shown in FIG. 2 may be performed by any of the illustrative systems described herein, such as the system 100. For example, any of the operations may be performed at the user device 102 and/or server 104.

At operation 202, the method 200 may include generating a knowledge set based on at least one query log and at least one domain-specific document. The knowledge set may be stored at a suitable data store for future processing, such as the database data store 114.

The query log may include records of previously executed structured language queries (e.g., SQL queries) and/or metadata regarding the executed structured language queries. The metadata may include any suitable type of metadata, such as timestamps, user identifiers, execution costs, error codes, and/or performance metrics.

The domain-specific documents may include documents that correspond to a particular domain, such as technical manuals, data dictionaries, schema documentation, regulatory filings, compliance guidelines, business glossaries, scientific publications, and/or training materials. The domain-specific documents may correspond to any suitable domain, such as financial domains, healthcare domains, manufacturing domains, retail domains, energy domains, transportation domains, computing domains, research domains, and/or education domains.

The domain-specific documents may include and/or define terminology or practices that are specific to the corresponding domain. For example, in the financial domain, the domain-specific documents may specify standardized definitions of metrics such as “quarter-over-quarter growth” or “return per viewer.” In the healthcare domain, the domain-specific documents may define coding standards, medical terminologies, and/or reporting requirements.

The knowledge set may be any suitable structured set of information relevant to generating structured language queries for execution against a database, such as the database 106. The knowledge set may serve as a repository of contextual information for query generation. For example, the knowledge set may include generation instructions, sub-expressions representing structured language query examples, and/or a schema representation indicating the structure of the database.

The generation instructions of the knowledge set may include instructions indicating how to interpret natural language inputs and convert them to structured language queries. The generation instructions may be derived from exemplary queries (e.g., from the query log) and the domain-specific document. The generation instructions may be represented in natural language and/or structured language sub-expressions.

The sub-expressions of the knowledge set may represent various structured language queries in a decomposed format. The sub-expressions may be derived from structured language queries, such as queries from the query log and/or queries received directly from domain experts. To generate the sub-expressions, the received queries may be reformatted into a common table expression (CTE)-based sketch, which provides an intermediate abstraction that separates complex queries into modular, reusable components. Each reformatted query may be decomposed into subqueries based on WITH clauses. Each subquery may then be broken down into sub-expressions based on inner clauses, such as SELECT clauses, WHERE conditions, GROUP BY statements, JOIN operations, and/or ORDER BY directives.

In some embodiments, the sub-expressions may be augmented with natural language annotations that describe the meaning or purpose of each component. The annotations may provide additional information needed to interpret ambiguous or domain-specific queries. For example, a JOIN clause may be annotated as “combine customer and orders tables by matching customer ID.” The annotations may be generated automatically (e.g., using LLMs) and/or received from domain experts.

The schema representation of the knowledge set may provide an outline of the structure of the database. The schema representation may be extracted directly from the database and/or obtained from database documentation. The schema representation may include various fields for representing the database structure, such as table names, column names, column types (e.g., categorial, numerical, textual, temporal, etc.), column descriptions (e.g., business contexts, semantic meanings, etc.), and/or representative column data samples.

In some embodiments, the schema representation may be supplemented with contextual annotations. For example, categorial column names may be annotated with domain-specific terminology, abbreviations, and/or synonyms frequently encountered in natural language inputs. Numeric column names may be annotated with units of measurement (e.g., dollars, percentages, milliseconds, etc.). Temporal column names may be annotated with business semantics, such as fiscal quarters or academic terms.

In some embodiments, data at the knowledge set may be organized based on at least one characteristic, such as domain, user intent, complexity level, time of use or generation, source type, and/or schema structure. The data may be partitioned by the characteristic. For example, the generation instructions and/or sub-expressions may be partitioned by user intent. The user intent may represent the high-level task requested by a user, such as filtering, aggregation, comparison across time periods, and/or ranking.

At operation 204, the method 200 may include receiving a natural language query for a database. The natural language query may include any query expressed in ordinary human language. For example, an exemplary natural language query may be “show me all sales from last month.” The natural language query may include terminology or phrases that are specific to a particular domain. The natural language query may be sent from any suitable system and/or device, such as the user device 102. A user may input the natural language query via a user interface (e.g., a command line interface), application, and/or service executing at the system and/or device.

At operation 206, the method 200 may include retrieving data relevant to the natural language query from the knowledge set. For example, the relevant data may include relevant generation instructions, relevant sub-expressions, and/or relevant elements of the schema representations.

In some embodiments, the natural language query may be reformatted into a canonical form (e.g., before retrieving the relevant data). Reformatting may include operations such as normalizing terminology, resolving synonyms, standardizing tense or phrasing, and/or removing extraneous words or noise. The reformatting may ensure that queries with similar meaning but different linguistic phrasing are treated consistently during downstream processing.

The relevant data may be identified using any suitable filtering technique. For example, the relevant data may be identified based on a similarity search. The natural language query may be analyzed to determine at least one characteristic of the natural language query, such as user intent. The entries in the knowledge set (e.g., the generation instructions and/or sub-expressions) may be ranked based on similarity to the natural language query according to the characteristic. Entries with sufficiently high similarity (e.g., having a similarity score exceeding a threshold) may be selected as relevant data. For example, entries with a user intent sufficiently similar to the user intent of the natural language query may be selected as relevant data.

In some embodiments, the relevant data may be retrieved from the knowledge set in a particular order. For example, the relevant sub-expressions may be retrieved first, followed by the relevant generation instructions, and finally the relevant elements of the schema representation. In some embodiments, the generation instructions at the knowledge set may be ranked based on similarity using the relevant sub-expressions.

In some embodiments, at least one machine learning model may be used to identify the relevant data. For example, an LLM may be configured to identify and remove irrelevant elements of the schema representation, such as irrelevant tables or columns. The function of the LLM may be to output a minimally sized schema representation that is still sufficient to answer the natural language query. A minimum element quota may be enforced to prevent over-pruning.

In some embodiments, the filtering techniques described above may be applied only if the size of the knowledge set (and/or sections of the knowledge set) exceeds a predetermined threshold. For example, the entire schema representation may be preserved if the size of the schema representation does not exceed a predetermined threshold.

At operation 208, the method 200 may include generating, based on the relevant data and the natural language query, a candidate structured language query using a machine learning model.

The candidate structured language query may be generated using any suitable technique. For example, in some embodiments, a reasoning plan may be constructed from the natural language query and/or the relevant data from the knowledge set. The reasoning plan may be a chain-of-thought (CoT) reasoning plan that outlines a sequence of operations for generating the structured language query. In this manner, the generation process may be decomposed into multiple intermediate steps. In some embodiments, the CoT reasoning plan may be represented as a directed sequence or graph indicating dependencies between operations. For example, an aggregation step may depend on a prior filtering step. Other exemplary types of reasoning plans may include tree-of-thoughts reasoning plans and/or program-of-thoughts reasoning plans.

In some embodiments, the reasoning plan may be augmented with pseudo-structured language query examples (e.g., pseudo-SQL statements derived from the knowledge set). The examples may include intermediate representations of structured language queries that capture high-level structure, operations, and/or relationships. For example, the examples may include partial query sketches, templated sub-expressions, and/or illustrative CTE structures.

In some embodiments, the candidate structured language query may be generated using a machine learning model, such as an LLM. The model may be configured to receive the natural language query, the relevant data, and/or the reasoning plan as inputs and output the candidate structured language query. In some embodiments, the model may output multiple candidate queries, which may be ranked according to predefined criteria, such as syntactic validity, semantic plausibility, and/or estimated execution efficiency.

At operation 210, the method 200 may include presenting the candidate structured language query for execution against the database. The candidate structured language query may be parsed and executed by a database management system, such as the DBMS 116. The resulting execution may be tailored for the domain corresponding to the database. For example, the execution may be tailored for patients records or clinical trial data at a healthcare database.

While the method 200 is shown as including operations 202 to 210, it is to be appreciated that the method 200 may include any number of additional and/or alternative operations. For example, in some embodiments, the candidate structured language query may be updated based on feedback after executing the query. The feedback may include any suitable type of feedback, such as execution error reports (e.g., reports from the database management system), model-based assessments, and/or human feedback.

The execution error reports may indicate parsing errors (e.g., unrecognized keywords, unmatched parentheses, and/or improper clause ordering) and/or runtime errors (e.g., applying operations to incompatible data types). The execution error reports may include structured descriptions of the errors, such as natural language descriptions. The error reports may be provided by the database management system (e.g., after parsing the candidate structured language query).

The model-based assessments may be generated from a machine learning model configured to determine the correctness of the candidate structured language query using predefined criteria. For example, the machine learning model may detect whether the candidate structured language query aligns with the detected user intent, references non-existent schema elements, contains logically inconsistent conditions, and/or is unlikely to return meaningful results.

In some embodiments, the feedback may be provided to a machine learning model, such as an LLM. The model may be configured to receive the feedback and/or the candidate structured language query as inputs and output an updated candidate structured language query. In some embodiments, the feedback may be added to the knowledge set.

In some embodiments, the candidate structured language query may be updated iteratively until a correct query is generated (e.g., the feedback does not indicate any errors or deficiencies) and/or a maximum number of iterations is achieved. In some embodiments, the candidate structured language query may be updated each time new feedback is provided.

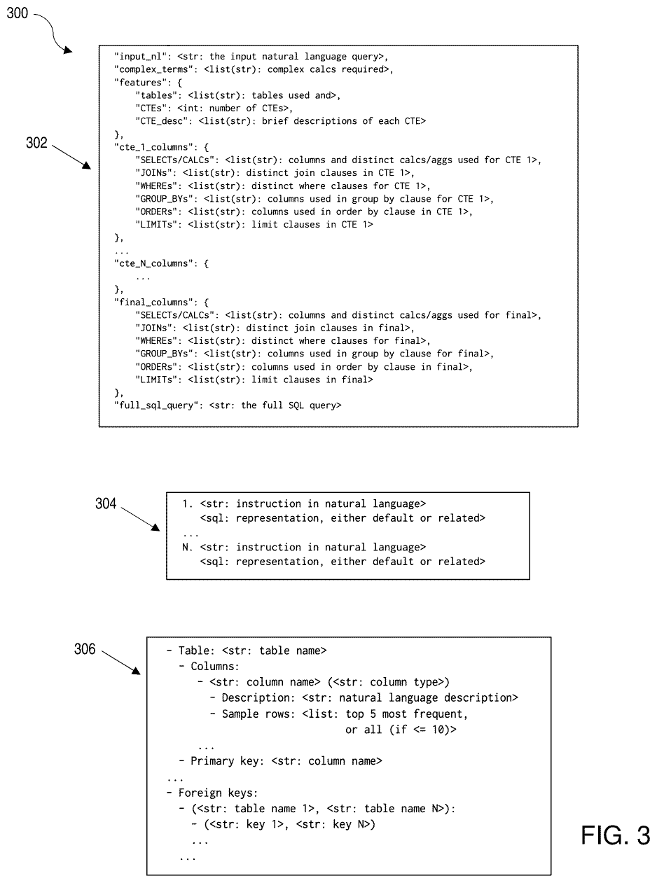

FIG. 3 illustrates a knowledge set 300 for end-to-end structured language query generation in accordance with one embodiment. As described above, the knowledge set 300 may be a structured set of contextual information for generating structured language queries. As shown, the knowledge set 300 may include sub-expressions 302, generation instructions 304, and a schema representation 306.

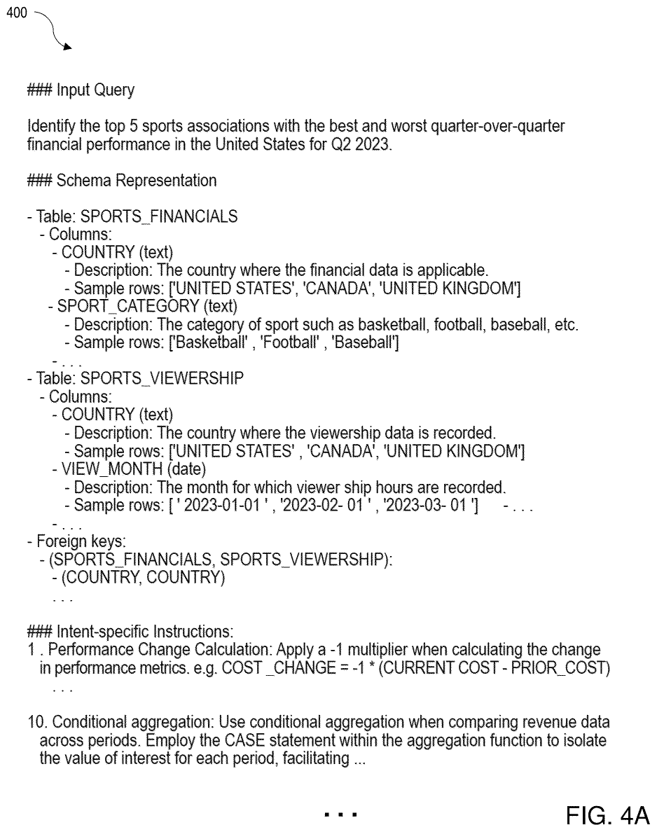

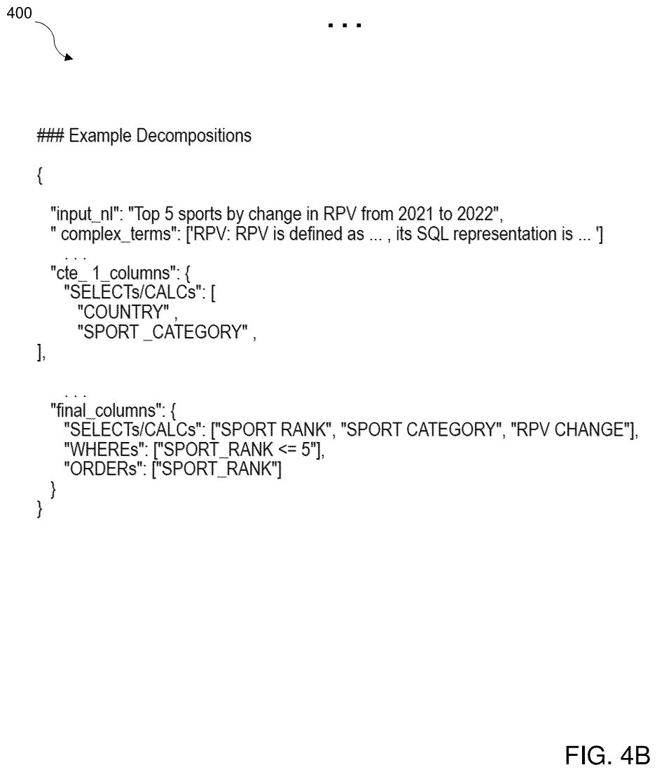

FIGS. 4A and 4B illustrate a command-line interface 400 for end-to-end structured language query generation in accordance with one embodiment. As shown, the interface 400 may receive an input query as input from a user for generating a structured language query. The interface 400 may present data relevant to the input query from a knowledge set, such as a relevant schema representation, relevant intent-specific generation instructions, and relevant example decompositions forming sub-expressions.

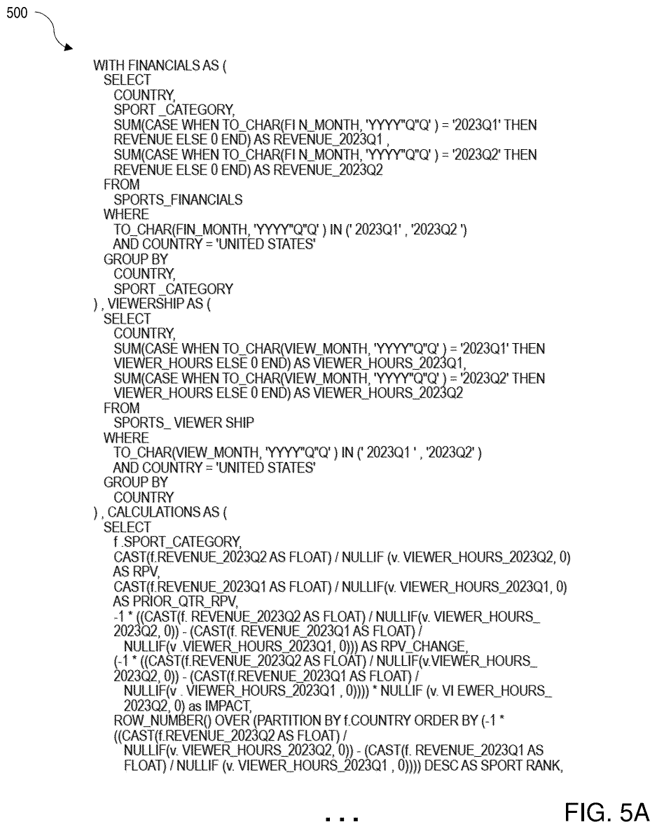

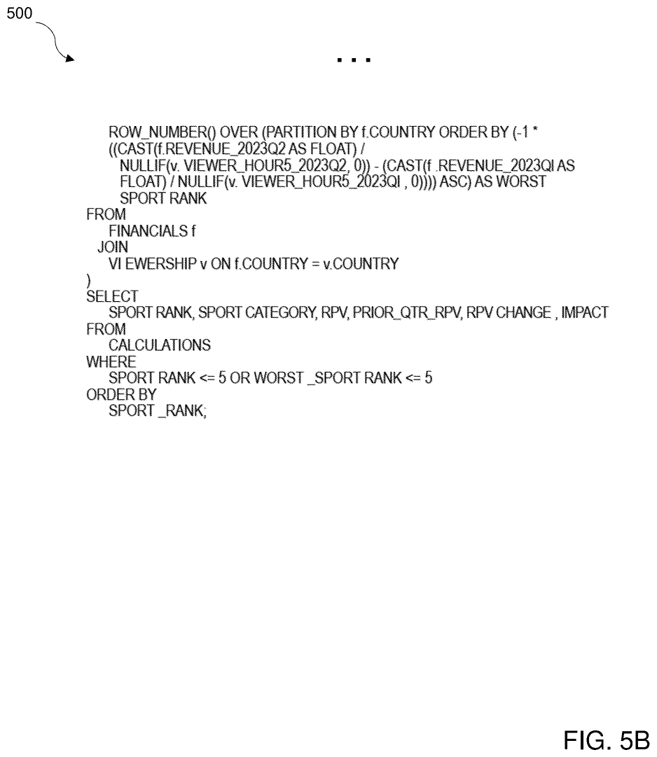

FIGS. 5A and 5B illustrate a structured language query 500 in accordance with one embodiment. The structured language query 500 may be generated from a natural language query and data from a knowledge set, such as the input query, schema representation, intent-specific generation instructions, and example decompositions shown in FIGS. 4A and 4B. The structured language query 500 may presented to a user at a user interface, such as the command-line interface 400.

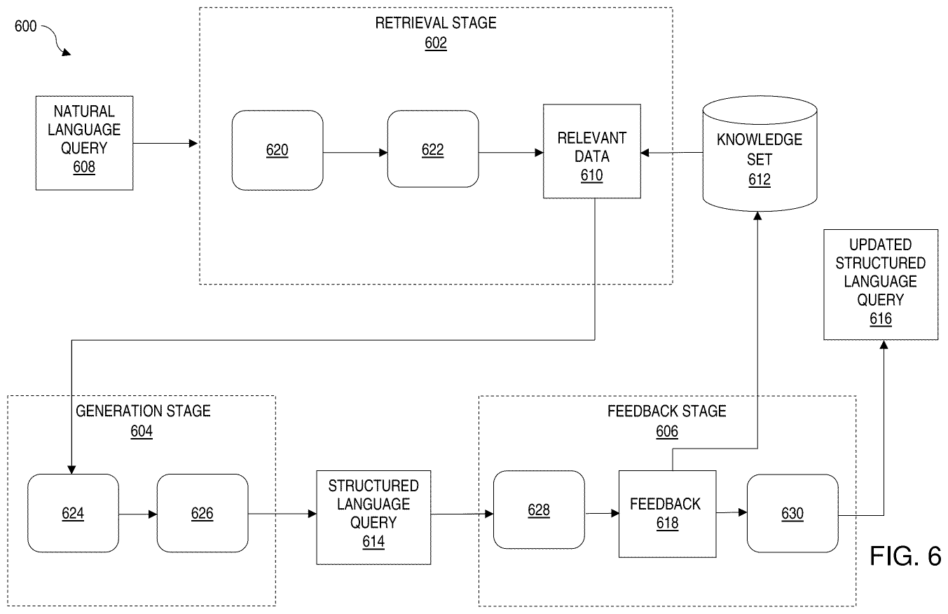

FIG. 6 illustrates a multi-stage pipeline 600 for end-to-end structured language query generation in accordance with one embodiment. The pipeline 600 may be implemented by any of the systems and/or components described herein, such as the system 100. The pipeline 600 may be configured to execute any of the operations described herein, such as the operations 202 to 210.

As shown, the pipeline 600 may include a retrieval stage 602, a generation stage 604, and a feedback stage 606. The retrieval stage 602 may receive a natural language query 608 as input and retrieve relevant data 610 from a knowledge set 612. The retrieval stage 602 may include a query reformatting operation 620 and an intent classification operation 622. At the query reformatting operation 620, the pipeline 600 may reformat the natural language query 608. At the intent classification operation 622, the pipeline 600 may classify the user intent of the natural language query 608 and retrieve the relevant data 610 based on the user intent.

The generation stage 604 may receive the relevant data 610 as input and generate a structured language query 614 as output. The generation stage 604 may include a reasoning plan generation operation 624 and a structured language query generation operation 626. At the reasoning plan generation operation 624, the pipeline 600 may generate a reasoning plan for generating the structured language query 614 based on the natural language query 608 and the relevant data 610. At the structured language query generation operation 626, the pipeline 600 may generate the structured language query 614.

The feedback stage 606 may receive the structured language query 614 and feedback 618 as inputs and output an updated structured language query 616. The feedback stage 606 may include an execution feedback operation 628 and a query update operation 630. At the execution feedback operation 628, the pipeline 600 may generate the feedback 618 (e.g., using model-based assessments). The feedback 618 may be related to the execution of the structured language query 614. At the query update operation 630, the pipeline 600 may generate the updated structured language query 616 based on the feedback 618 and the structured language query 614. The feedback 618 may be stored at the knowledge set 612 for future updates.

As described above, a system (e.g., the system 100) may automatically generate structured language queries from natural language queries using machine learning models such as LLMs. The system may use knowledge sets to capture domain-specific knowledge as input for the machine learning models.

In some embodiments, the system may learn continuously over time from feedback. For example, as described herein, the system may continuously update the knowledge set based on human feedback. The learning process may form a feedback loop where human feedback is repeatedly or iteratively incorporated into the system and used to regenerate past structured language queries or generate new structured language queries.

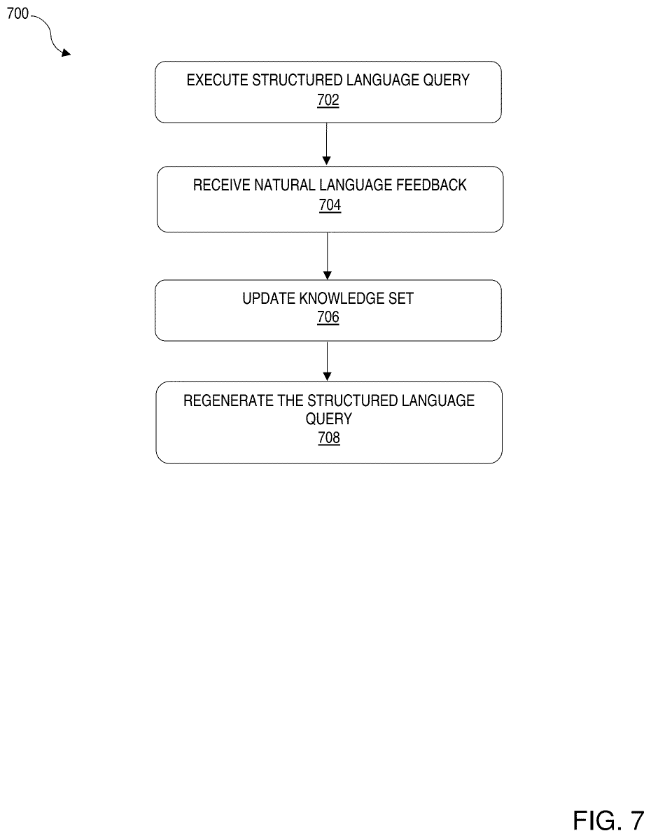

FIG. 7 illustrates a flowchart of a method 700 for end-to-end structured language query editing in accordance with one embodiment. While FIG. 7 shows illustrative operations according to one embodiment, other embodiments may omit, add to, reorder, and/or modify any of the operations shown in FIG. 7. Moreover, each of the operations depicted in FIG. 7 may be performed in any of the ways described herein. The operations shown in FIG. 7 may be performed by any of the illustrative systems described herein, such as the system 100. For example, any of the operations may be performed at the user device 102 and/or server 104.

Operation 702 includes executing a structured language query generated from a natural language query using a knowledge set. The structured language query may be generated using any of the methods described herein, such as the method 200. For example, a machine learning model may generate the structured language query using a knowledge set providing domain-specific knowledge. In some embodiment, the structured language query may have undergone model-based assessments and/or any other testing procedures.

In some embodiments, the structured language query may be executed within a testing or simulation environment. Data related to the execution of the structured language query may be presented to a user, such as via a user interface presented at a user device (e.g., the user device 102). For example, the user interface may present the output of the execution (e.g., query results), performance metrics related to the execution (e.g., latency times, errors, resource usage, etc.), natural language summaries of the execution, and/or visualizations related to the execution (e.g., graphs, plots, etc.). The user interface may be interactive, such that the user may interact with any of the data presented.

Operation 704 includes receiving natural language feedback regarding the execution of the structured language query. The natural language feedback may be human feedback received from any suitable individual, such as a subject matter expert (SME), business user, and/or an administrator. As used herein, an SME may include any individual with specialized domain expertise related to a structured language query. In some embodiments, the individual providing the natural language feedback may also have provided the natural language query for generating the structured language query.

In some embodiments, the natural language feedback may include qualitative feedback (e.g., description of errors, missing details, desired edits, etc.) and/or quantitative feedback (e.g., error rates, user satisfaction scores, objective completion rates, etc.). Exemplary natural language feedback may include “This response queries all sports organizations but I only want our organization” and “I would rate this query a 6 out of 10 because of the following reasons.” The natural language feedback may be received via the user interface.

The natural language feedback may relate to any aspect of the execution. For example, the natural language feedback may be related to the structured language query itself, the data entries from the knowledge set used to generate the structured language query, and/or the model that generated the structured language query.

Operation 706 includes updating the knowledge set based on the natural language feedback. For example, as described in more detail herein, the natural language feedback may be relevant to specific data entries within the knowledge set. The relevant data entries may be identified and updated within the knowledge set based on the natural language feedback. In some embodiments, the relevant data entries may be updated using a machine learning model, such as an LLM.

Operation 708 includes regenerating the structured language query based on the updated knowledge set. The structured language query may be regenerated using any of the methods described herein, such as the method 200. For example, the updated data entries may be retrieved and provided as input to a machine learning model to regenerate the structured language query.

In some embodiments, the method 200 may include generating at least one recommended edit related to the structured language query. For example, the recommended edit may be an edit to the structured language query itself, an edit to a model, and/or an edit to the knowledge set. The recommended edit may be generated based on the natural language feedback received at operation 704 and/or any other human feedback. The recommended edit may be presented at the user interface.

In some embodiments, the user interface may receive human feedback regarding the recommended edit. For example, the user may decline the recommended edit or select at least one edit. If the user declines the recommended edit, the user interface may prompt the user to approve the structured language query without the edit, prompt the user to provide additional feedback, and/or present additional recommended edits for user review. If the user selects at least one edit, the structured language query may be regenerated with the selected edit and executed. In some embodiments, the regenerated structured language query may be executed within a test or simulation environment. The user interface may receive human feedback regarding the execution, such as approval from the user to publish or store the regenerated structured language query.

In some embodiments, multiple feedback entries related to the structured language query may be received. The feedback entries may be provided by multiple individuals. In some embodiments, recommended edits may be generated after each feedback entry in real-time. In some embodiments, multiple feedback entries may be processed together in batches. For example, the feedback entries may be consolidated, such as by grouping similar feedback entries and/or feedback entries received within a certain time frame. Conflicting feedback entries may be resolved by scoring feedback entries based on priority and selecting feedback entries based on the scores. For example, feedback entries that are related to a higher number of individuals and/or are provided by the most reputable individuals may have higher priority scores. Individuals may have reputation scores that are determined based on factors such as individual types (e.g., SME, business user, administrator, etc.), expertise levels, and/or effectiveness of past feedback.

In some embodiments, a hybrid approach may be used to process multiple feedback entries. For example, real-time processing may be used in scenarios with higher-priority feedback or newly generated structured language queries, while batch processing may be used for periodic maintenance of the knowledge set.

In some embodiments, the recommended edits may include predicted edits generated before any human feedback is received. For example, the predicted edits may be based on past executions of similar structured language queries.

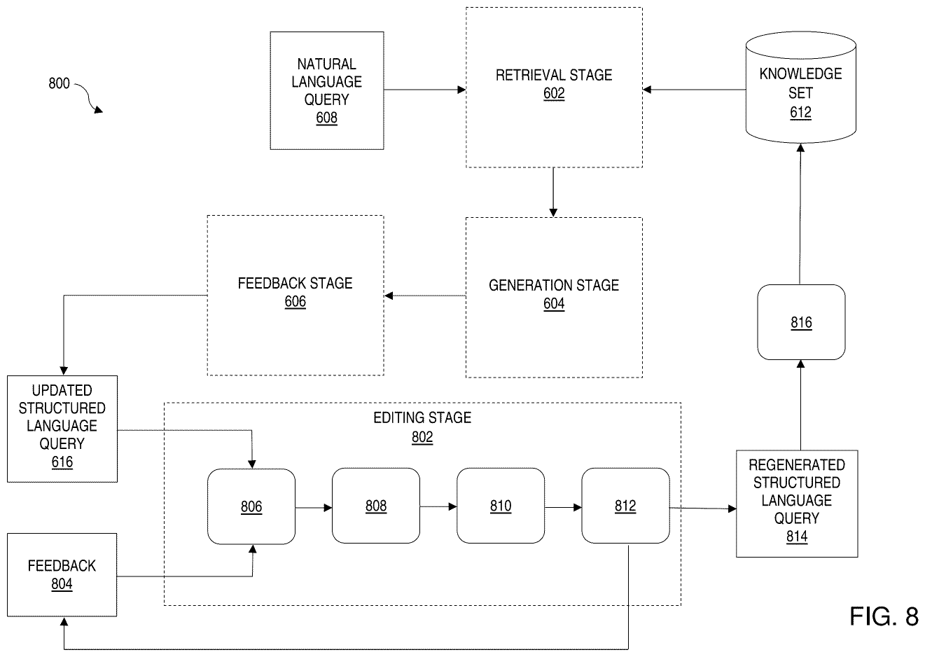

FIG. 8 illustrates a multi-stage pipeline 800 for end-to-end structured language query generation and editing in accordance with one embodiment. The pipeline 800 may be implemented by any of the systems and/or components described herein, such as the system 100. The pipeline 800 may be configured to execute any of the operations described herein, such as the operations 702 to 708.

As shown, the pipeline 800 may generate structured language queries in a similar manner to the pipeline 600. For example, the pipeline 800 may process the natural language query 608 through the retrieval stage 602, the generation stage 604, and the feedback stage 606 to generate the updated structured language query 616.

In some embodiments, the pipeline 800 may edit generated structured language queries and continuously learn over time via a feedback loop. For example, as shown, the pipeline 800 may include an editing stage 802 that feeds back into the knowledge set 612. The editing stage 802 may receive the updated structured language query 616 and feedback 804 as input. The feedback 804 may include natural language feedback received from any suitable individual, such as an SME or administrator. The editing stage 802 may include a relevant data operation 806, a feedback expansion operation 808, a planning operation 810, and an edit generation operation 812. The editing stage 802 may generate a regenerated structured language query 814 using the above operations.

The relevant data operation 806 may include identifying, from the knowledge set 612, data entries relevant to the feedback 804. Specific generation instructions, sub-expressions, and/or schema representations may be identified as relevant data entries.

The relevant data entries may be identified using any suitable technique. In some embodiments, for example, the relevant data entries may be identified using a similarity search. The feedback 804 may be analyzed to determine at least one characteristic of the feedback 804, such as user intent and/or type of feedback (e.g., semantic feedback, stylistic feedback, syntactic feedback, etc.). The data entries in the knowledge set 612 may be ranked based on similarity to the feedback 804 according to the characteristic. Data entries with sufficiently high similarity (e.g., having a similarity score exceeding a threshold) may be selected as relevant data entries. For example, data entries with user intents sufficiently similar to the user intent of the feedback 804 may be selected as relevant data.

In some embodiments, the similarity search may be an embeddings-based similarity search. The feedback 804 and the data entries in the knowledge set 612 may be converted into vector embeddings. Each embedding may indicate the contextual and syntactic meaning of the corresponding text. The embeddings may be generated using transformer-based encoders. The feedback embedding may be compared to the knowledge set embeddings using a similarity search (e.g., cosine similarity, inner-product correlation, etc.). Embeddings with the highest similarity values may be identified as embeddings of relevant data entries.

The feedback expansion operation 808 may include generating an explanation of why the data entries are relevant to the feedback 804. The explanation may include a natural language description. The description may indicate any shortcomings and/or inconsistencies of the data entries. For example, if the feedback 804 states “The query result includes all organizations, but it should only include our organizations,” the description may read “Instruction #7 lacks an ownership flag.” In some embodiments, the explanation may indicate the degree of relevancy for each data entry, such as by using a numerical score.

The planning operation 810 may include generating a plan for at least one edit related to the updated structured language query 616. For example, the plan may be a reasoning plan, such as a CoT reasoning plan that outlines a sequence of operations for generating the edit and how to apply the edit. Other exemplary types of reasoning plans may include tree-of-thoughts reasoning plans and/or program-of-thoughts reasoning plans.

The edit may include any relevant edit, such as edits to the updated structured language query 616, edits to the knowledge set 612, and/or edits to a model. The plan may outline the required transformations needed for the edit, such as insertions, deletions, and/or substitutions.

The edit generation operation 812 may include generating edits using the plan. The edits may include edits to the relevant data entries and/or any other relevant edits. The edits may be generated using a machine learning model that receives the plan, the feedback 804, and/or the relevant data entries as input. The edits may be recommended edits that need to be approved before being applied to the updated structured language query 616.

In some embodiments, feedback regarding the generated edits may be received. For example, the feedback may include a selection of at least one generated edit. In some embodiments, the selected edits may undergo automated evaluations (e.g., model-based assessments) before being applied. In some embodiments, the structured language query may be executed with the selected edits at a test or simulated environment.

The selected edits may be used to regenerate the updated structured language query 616 as the regenerated structured language query 814. In some embodiments, the updated structured language query may be regenerated after receiving user approval to proceed with regeneration (e.g., after testing the selected edits).

In some embodiments, the feedback may indicate disapproval of the generated edits. The editing stage 802 may be performed iteratively until at least one edit and/or structured language query is approved. In this manner, human feedback may be iterated upon until a satisfactory query is generated.

In some embodiments, the selected edits and/or the regenerated structured language query 814 may undergo an evaluation operation 816. The evaluation operation 816 may include automated evaluations (e.g., model-based assessments) and/or manual evaluations (e.g., human feedback). The evaluations may use any suitable criteria, such as the degree of improvement (e.g., increases in accuracy, execution efficiency, etc.) from the updated structured language query 616. In some embodiments, the pipeline 800 may learn from the evaluations. For example, the pipeline 800 may determine what types of edits provide the most improvement to structured language queries. Such edits may be prioritized for recommendations in future editing processes.

In some embodiments, approved edits may be stored at the knowledge set 612 as updated data entries. The regenerated structured language query 814 may be stored at an appropriate data store after being approved, such as the server data store 112. In some embodiments, the approved edits and/or the regenerated structured language query 814 may be stored at a version-controlled data store, such as a distributed blob storage system and/or a git repository. The version-controlled data store may allow retrieval of prior versions, thereby enabling auditability and controlled rollback of prior releases.

In some embodiments, editing events may be logged and stored. For example, the approved edits and/or the regenerated structured language query 814 may be stored with metadata such as version identifiers, creation or update timestamps, authors, update descriptions, and/or authentication artifacts.

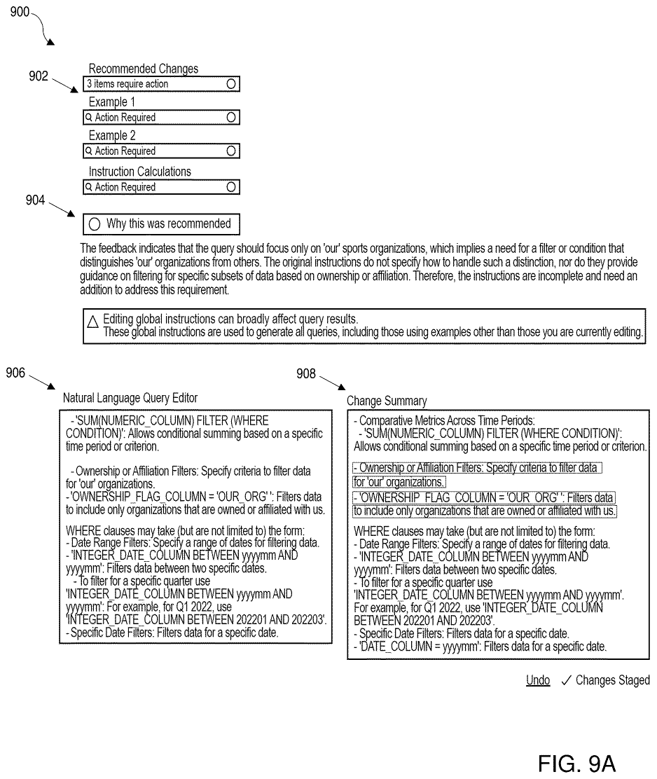

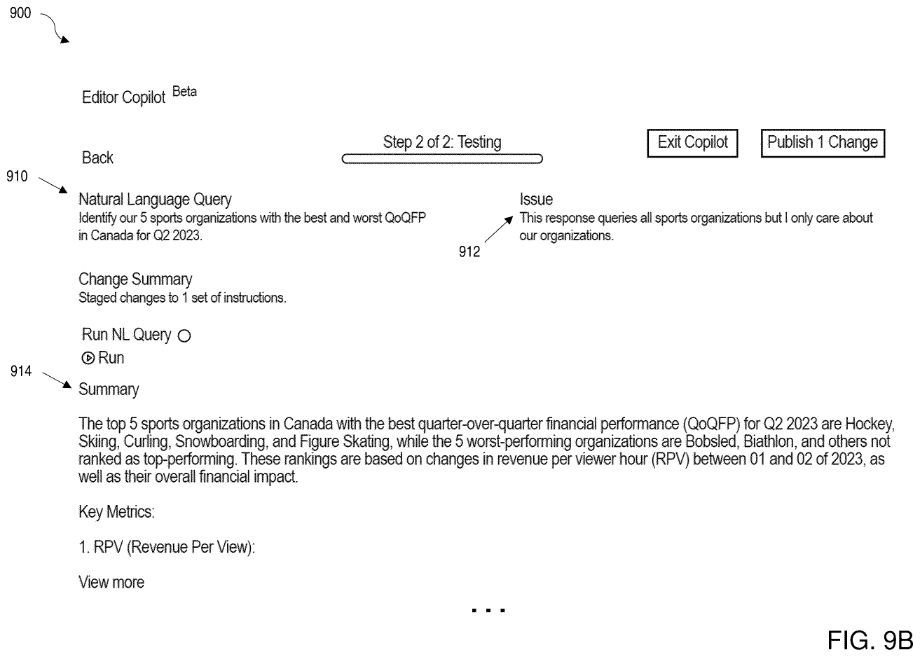

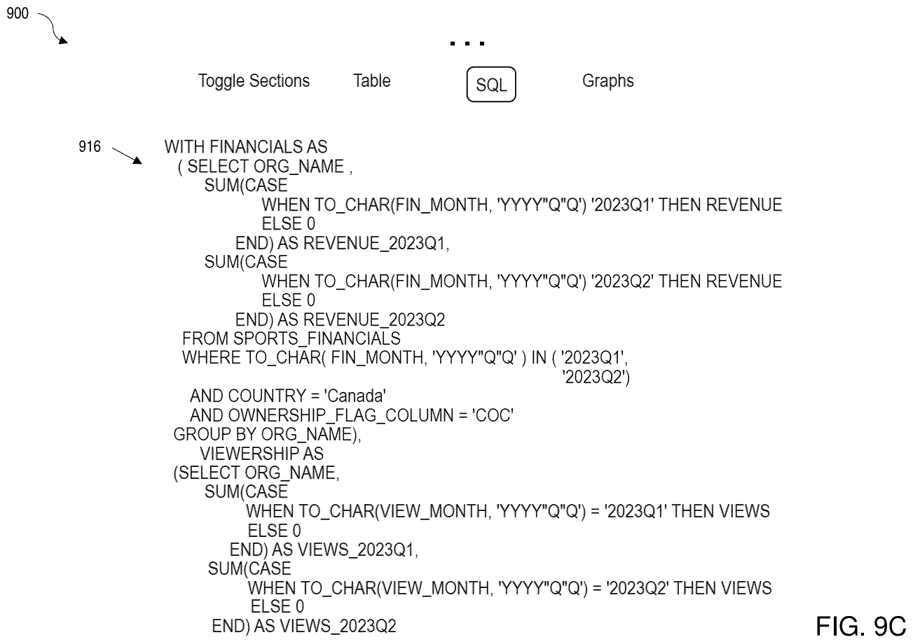

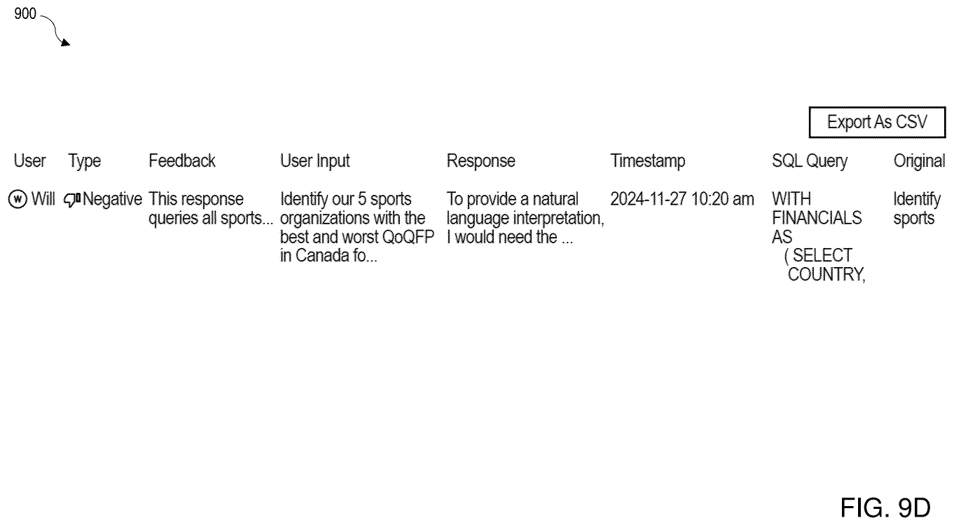

FIG. 9A illustrates a user interface 900 for end-to-end structured language query generation and editing. The user interface 900 may be rendered by any suitable application and/or service, such as the applications 108. The user interface 900 may be presented at any suitable device and/or system, such as the user device 102.

In some embodiments, the user interface 900 may allow a user to manage various aspects related to generating and editing structured language queries. The user interface 900 may facilitate the full life cycle of a structured language query, including generation, editing, and/or execution.

In some embodiments, the user interface 900 may present data related to a structured language query being reviewed by a user. As shown, for example, the user interface 900 may present a recommended edits list 902, a recommendation description 904, a query editor 906, and a change summary 908. Any of the components shown may be presented as a separate panel within the user interface 900.

The recommended edits list 902 may include recommended edits related to the structured language query. As described above, the recommended edits may be generated in response to human feedback, such as feedback received at the user interface 900. In some embodiments, the recommended edits may be edits to data entries of a knowledge set used to generate the structured language query. As shown, for example, the recommended edits list 902 may include three recommended edits, two for structured language query examples and one for generation instructions. The user interface 900 may allow the user to select any of the recommended edits to regenerate the structured language query.

In some embodiments, the recommended edits list 902 may be ranked according to the confidence or priority level of each edit. The recommended edits list 902 may be color-coded to indicate aspects of each edit, such as a review status (e.g., whether each edit has been reviewed or approved) and/or a confidence or priority level.

The recommendation description 904 may include descriptions of various aspects of the recommended edits, such as a description of the recommended edits, why the recommended edits are recommended, the human feedback used to generate the recommended edits, shortcomings of the structured language query, why any listed data entries are relevant, predicted consequences of accepting or declining the edits, and/or recommended actions.

The query editor 906 may present the recommended edits within the context of the surrounding text. For example, the query editor 906 may present the structured language query and/or data entries with the recommended edits applied. The change summary 908 may highlight the recommended edits and/or otherwise indicate how the text has changed from the current version. In some embodiments, the query editor 906 may allow the user to directly edit the recommended edits. The query editor 906 and/or the change summary 908 may update to present the user edits in real-time. In some embodiments, the user interface 900 may present alerts if the user edits would cause any errors or issues during execution.

In some embodiments, the user interface 900 may allow collaboration among multiple users. For example, the query editor 906 may allow multiple users to edit text simultaneously. All the edits may be presented in real-time. If conflicting edits are made, the user interface 900 may present an alert to the users and/or recommend a resolution strategy. For example, the user interface 900 may indicate a preferred edit and/or confidence levels for each conflicting edit. In some embodiments, editing privileges may depend on an access level for each user.

FIGS. 9B and 9C illustrate an alternate embodiment of the user interface 900 for end-to-end structured language query generation and editing. FIGS. 9B and 9C illustrate the user interface 900 after the structured language query has been regenerated with selected edits. The user interface 900 may present data related to the regenerated structured language query. As shown, for example, the user interface 900 may present the natural language query 910 used to generate the structured language query, the feedback 912 used to generate the selected edits, a summary 914 describing the selected edits and/or the regenerated structured language query, and the regenerated structured language query 916. The user interface 900 may present the data immediately after the structured language query has been regenerated.

In some embodiments, the user interface 900 may allow the user to approve the regenerated structured language query 916, make any further edits, and/or initiate testing procedures. For example, the user interface 900 may present a selectable option to initiate an automated evaluation of the regenerated structured language query 916.

FIG. 9D illustrates another alternate embodiment of the user interface 900. The user interface 900 may allow the user to manage a knowledge set used for generating structured language queries. As shown, for example, the user interface 900 may present data related to the knowledge set, such as past feedback, past edits, past edit types, related structured language queries, timestamps (e.g., data entry timestamps, edit timestamps, etc.), usage history or frequency, and/or authors of data entries or edits. In some embodiments, the user interface 900 may present evaluation scores related to the knowledge set, such as accuracy, coverage, recency, and/or consistency scores. The user interface 900 may allow the user to order the data entries based on the presented data, such as the timestamps. In some embodiments, the user interface 900 may allow reversion to past versions of the data entries.

In some embodiments, the user interface 900 may allow the user to provide feedback for the knowledge set. For example, the user may directly edit data entries presented at the user interface 900 and/or provide natural language feedback regarding the data entries. The user interface 900 may present updated evaluation scores and/or other suitable updated data based on the feedback.

While FIGS. 9A to 9D depict various components of the user interface 900, it is to be appreciated that the user interface 900 may present any suitable component. For example, the user interface 900 may present graphical plots and/or other visualizations related to the structured language query or the knowledge set. For example, the user interface 900 may present a heat map that indicates what types of structured language queries or data entries have the highest error or edit rates. In some embodiments, the user interface 900 may present a timeline that shows the change of the knowledge set or a structured language query over time using a performance indicator such as user scores or latency rates. The timeline may include indicators (e.g., nodes) of relevant events such as editing events. In some embodiments, the user interface 900 may present the knowledge set as a graph, where nodes represent entries in the knowledge set and edges represent relationships or dependencies between the entries. In some embodiments, in response to a natural language query, the user interface 900 may present similar natural language queries and/or their corresponding structured language queries.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A computer-implemented method for structured language query editing, the method being executed by a processing system comprising at least one processor and memory, the method comprising:
executing a structured language query generated from a natural language query using a knowledge set;
receiving, at an interactive user interface from a user, natural language feedback regarding the execution of the structured language query;
updating the knowledge set based on the natural language feedback; and
regenerating the structured language query based on the updated knowledge set.

2. The computer-implemented method of claim 1, further comprising:
identifying, from the knowledge set, data relevant to the natural language feedback; and
generating a chain-of-thought (CoT) reasoning plan based on the relevant data,
wherein the knowledge set is updated based on the CoT reasoning plan.

3. The computer-implemented method of claim 2, further comprising generating an explanation of why the data is relevant.

4. The computer-implemented method of claim 2, wherein the identifying the relevant data comprises performing a similarity search based on at least one characteristic of the natural language feedback.

5. The computer-implemented method of claim 2, wherein the structured language query is generated using a second CoT reasoning plan.

6. The computer-implemented method of claim 1, wherein the knowledge set is repeatedly updated until the user approves a version of the structured language query.

7. The computer-implemented method of claim 1, further comprising presenting, at the interactive user interface, at least one of the updated knowledge set or the regenerated structured language query.

8. The computer-implemented method of claim 1, further comprising:
presenting, at the interactive user interface, data regarding the execution of the structured language query;
presenting, at the interactive user interface, at least one recommended edit to the knowledge set based on the natural language feedback; and
receiving, at the interactive user interface, a selection of at least one recommended edit.

9. The computer-implemented method of claim 8, further comprising:
executing the structured language query with the at least one selected edit at a test environment; and
receiving, at the interactive user interface, approval from the user to regenerate the structured language query with the at least one selected edit.

10. The computer-implemented method of claim 1, wherein the knowledge set comprises generation instructions and sub-expressions representing structured language queries.

11. The computer-implemented method of claim 1, wherein the knowledge set is partitioned according to a user intent of the natural language query.

12. A system for structured language query editing, comprising:
an interactive user interface configured to perform the step of receiving, from a user, natural language feedback regarding an execution of a structured language query generated from a natural language query using a knowledge set;
memory storing instructions; and
a processor executing the instructions to perform the steps of:
executing the structured language query;
updating the knowledge set based on the natural language feedback received at the interactive user interface; and
regenerating the structured language query based on the updated knowledge set.

13. The system of claim 12, wherein the processor is further configured to perform the steps of:
identifying, from the knowledge set, data relevant to the natural language feedback; and
generating a chain-of-thought (CoT) reasoning plan based on the relevant data,
wherein the knowledge set is updated based on the CoT reasoning plan.

14. The system of claim 12, wherein the knowledge set is repeatedly updated until the user approves the regenerated structured language query.

15. The system of claim 12, wherein the interactive user interface is further configured to perform the step of presenting at least one of the updated knowledge set or the regenerated structured language query.

16. The system of claim 12, wherein the interactive user interface is further configured to perform the steps of:
presenting data regarding the execution of the structured language query;
presenting at least one recommended edit to the knowledge set based on the natural language feedback; and
receiving a selection of at least one recommended edit.

17. The system of claim 16, wherein the processor is further configured to perform the step of executing the structured language query with the at least one selected edit at a test environment,
and wherein the interactive user interface is further configured to perform the step of receiving approval from the user to regenerate the structured language query with the at least one selected edit.

18. The system of claim 12, wherein the knowledge set comprises generation instructions and sub-expressions representing structured language queries.

19. The system of claim 12, wherein the knowledge set is partitioned according to a user intent of the natural language query.

20. A computer program product embodied in a non-transitory computer readable storage medium and comprising computer instructions for:
executing a structured language query generated from a natural language query using a knowledge set;
receiving, at an interactive user interface from a user, natural language feedback regarding the execution of the structured language query;
updating the knowledge set based on the natural language feedback; and
regenerating the structured language query based on the updated knowledge set.
